(19) United States
(12) Patent Application Publication
(10) Pub. No.: US 2026/0285318 A1
(43) Pub. Date: Sep. 24, 2026

(54) Computing Device for an Assistance System of a Vehicle for Carrying Out System-Initiated Automated Lane Change Maneuvers, Assistance System, and Method

(71) Applicant: Bayerische Motoren Werke Aktiengesellschaft, Muenchen (DE)

(72) Inventors: Moritz BLASCHE, Muenchen (DE); Sami FAYAD, Muenchen (DE); Tim FRICKE, Karlsfeld (DE); Michael GUTBROD, Muenchen (DE); Martin HERACLES, Muenchen (DE); Stephan NIERMANN, Hebertshausen (DE); Dominik RIETH, Dietersheim Eching (DE); Kai STIENS, Muenchen (DE)

(21) Appl. No.: 19/475,512

(22) PCT Filed: Apr. 18, 2024
(86) PCT No.: PCT/EP2024/060579

§ 371 Date: Oct. 15, 2025

(30) Foreign Application Priority Data
Apr. 21, 2023 (DE) 10 2023 110 220.6

(51) Int. Cl. B60W 30/18; B60W 10/20; B60W 40/08; B60W 50/14

(52) U.S. Cl. CPC B60W 30/18163; B60W 10/20; B60W 40/08; B60W 50/14; B60W 2050/146; B60W 2540/215; B60W 2540/225; B60W 2540/229; B60W 2554/406

(57) ABSTRACT

A computing device for an assistance system for automatic lateral control of a vehicle determines a free gap for an automated lane change maneuver. An offer signal for outputting an offer to a driver for the automated lane change maneuver is output. Attentiveness data describing a direction of view and/or a head orientation of the driver is received. It is determined whether a situational awareness of the driver for the automated lane change maneuver exists as acceptance of the offer. The situational awareness describes turning of the direction of view and/or the head orientation towards a region assigned to the free gap. An activation signal for automatically activating indicators of the vehicle is output. A steering signal for actuating a steering system of the vehicle in order to carry out the automated lane change maneuver is output when the situational awareness exists.

### BACKGROUND AND SUMMARY

The present invention relates to a computing device for an assistance system of a vehicle. The present invention further relates to an assistance system for a vehicle. The present invention moreover relates to a method for the automated lateral control of a vehicle.

Assistance systems are known from the prior art, by means of which an at least partially automated lateral control of the vehicle can be executed. Assistance systems of this type having partially automated lateral control support the driver by the assumption of the steering function. By way of distinction from lane keeping assistance systems, this support is not restricted to situational interventions, for example in the event of a lane departure, but supports the driver continuously for the purposes of tracking. In the operation of the assistance system, in general, carriageway markings and/or a trajectory executed by a leading vehicle are captured, and are employed as a basis for the planned trajectory of the ego-vehicle.

To a degree, these known assistance systems for partially automated lateral control enable the driver to intermittently remove their hands from the steering wheel. This is also described as a “tolerated hands-off state”. However, in the operation of the assistance system, after a relatively short time interval, by means of optical and/or acoustic indications, the driver is alerted to the driving function, and is instructed to return their hands to the steering wheel.

Moreover, lane change assistance systems are known from the prior art, which systems support the driver in lane change maneuvers. In known lane change assistance systems having an automated or automatic lane change function, a specific operator control action on the part of the driver is indicative of an intention to change lanes. In the event of the detection of such an operator control action, by means of the lane change assistance system, the vehicle is maneuvered along a planned trajectory into the adjoining lane or into the target lane using automated lateral control and, in general, also using automated longitudinal control. In lane change assistance systems of this type, the intention of the driver to change lanes is customarily signaled by the actuation of a corresponding operator control element, for example of an indicator lever, in order to activate direction of travel indicators which are visible from the exterior of the vehicle.

The object of the present invention is the disclosure of a solution by means of which an improvement of automated lane change maneuvers with respect to safety and convenience is enabled.

According to the invention, this object is fulfilled by a computing device, by an assistance system and by a method having the features according to the independent claims. Advantageous further developments of the present invention are disclosed in the dependent claims.

A computing device according to the invention for an assistance system for the automated lateral control of a vehicle is designed to determine a free gap for an automated lane change maneuver by reference to environmental data. The computing device is additionally designed to output an offer signal for outputting an offer to a driver for the automated lane change maneuver. The computing device is further designed to receive attentiveness data, which attentiveness data describe a viewing direction and/or a head orientation of the driver. The computing device is moreover designed to determine whether a situational awareness of the driver for the automated lane change maneuver is in force by way of an acceptance of the offer, which situational awareness describes a turning of the viewing direction and/or of the head orientation towards a region which is assigned to the free gap. The computing device is furthermore designed to output an activation signal for automatically activating direction of travel indicators of the vehicle. The computing device is additionally designed to output a steering signal for actuating a steering system of the vehicle for the execution of the automated lane change maneuver, in the event that situational awareness is in force.

By means of the computing device, an automated lane change maneuver can be prepared and executed. In order to enable the appraisal of a current traffic situation with respect to the necessity for a lane change, environmental data can be received by means of the computing device, which data describe further road users in the environment of the vehicle. Environmental data can describe the positions of further road users. In particular, environmental data can describe the lane in which respective road users are presently located. Moreover, environmental data can describe the respective present speeds of further road users. By means of the computing device, environmental data can be received from at least one environmental sensor of the vehicle or of the assistance system. The at least one environmental sensor can be a camera, a radar sensor, a LiDAR sensor, an ultrasonic sensor, or similar.

By means of the computing device of the assistance system, the lane change maneuver from the lane in which the vehicle is presently located into the adjoining lane or target lane can be planned. To this end, for example, a corresponding trajectory can be calculated, along which it is intended that the vehicle should be maneuvered. For the planning of the lane change maneuver, a check can firstly be executed as to whether a free gap for the vehicle between further road users is available in the adjoining lane or otherwise. In particular, a free gap describes a sufficient room for maneuver for the safe execution of the lane change. In the event that a gap is detected, a check can be executed as to whether this gap is appropriate for the lane change maneuver, with respect to the dimensions thereof.

If an appropriate gap for the lane change maneuver is available, an offer signal can be output by means of the computing device or transmitted to an output device. By means of the output device, the offer or a proposal for the automated lane change maneuver can be output for the attention of the driver. The output device can comprise a read-out or a display, and the offer can be output for the attention of the driver optically, or in the form of a read-out. By means of the read-out, the current traffic situation in the environment of the vehicle can be displayed to the driver. For example, on the read-out, a depiction of the vehicle and of further road users in the environment of the vehicle can be represented. Moreover, lanes can be indicated on the read-out.

In conjunction with the output of the offer, a symbol which describes the planned lane change maneuver can be displayed to the driver. The symbol can be, for example, a trajectory or an arrow which illustrates the movement of the vehicle associated with the planned lane change. Alternatively or additionally, in conjunction with the offer, a text can be displayed for the attention of the driver which is indicative of the planned lane change maneuver. The offer can moreover be output acoustically, for example in the form of an additional information tone or in the form of a voice prompt. Alternatively or additionally, a haptic signal can be output for the attention of the driver in conjunction with the offer.

Moreover, by means of the computing device, driver attentiveness data are received from a driver monitoring device. By means of the driver monitoring device, driver attentiveness data can be supplied, which data describe a current viewing direction and/or a current head orientation of the driver. The driver monitoring device can comprise, for example, an interior camera which is directed towards the driver. By means of the driver monitoring device, by reference to the capture of the nose of the driver, the head position or head orientation can be determined. Moreover, by means of the driver monitoring device, the position of the pupils of the driver, and thus the viewing direction of the driver can be determined. By means of the driver monitoring device, it can also be detected whether the eyes are open or closed. The driver monitoring device can comprise infrared light sources, such that the head position and/or viewing direction of the driver can be ascertained, even in the event that sunglasses are worn and/or in the event of dark ambient conditions. Moreover, by reference to attentiveness data or by reference to data from the driver monitoring device, a physical posture or an orientation of the upper body of the driver can be determined.

On the basis of data from the driver monitoring device, a situational awareness of the driver with respect to the forthcoming automated lane change maneuver can be determined. In the event that the computing device or the assistance system has detected the situational awareness of the driver, this can be interpreted as an acceptance of the offer. In order to execute a check as to whether situational awareness is in force, it is ascertained whether the line of vision and/or head orientation of the driver is directed towards at least one region which is assigned to the free gap. In this appraisal, the general physical posture of the driver can also be considered. Preferably, a check can be executed as to whether the driver completes a confirmatory look.

In particular, this means that the situational awareness of the driver with respect to the lane change maneuver is assumed to be in force in the event that the driver looks at the free gap, or in the direction of the free gap, and thus confirms the availability of traffic space for the automated lane change maneuver. In particular, the driver then assumes full responsibility for the subsequent automated lane change maneuver. Preferably, this also applies to the check as to whether the target lane, which has already been detected by the vehicle or by the assistance system itself, is genuinely free.

The externally visible direction of travel indicators can be automatically activated by means of the computing device in preparation for the automated lane change maneuver. In particular, direction of travel indicators can be activated with no preliminary actuation of an operator control element, for example of an indicator lever. In particular, direction of travel indicators can be activated automatically, in the event that the offer for the automated lane change maneuver has been accepted by the driver.

By the automatic activation of direction of travel indicators, the situational awareness of the driver can be further monitored with respect to the subsequent automated lane change maneuver. Activation of direction of travel indicators can also be displayed to the driver in the interior of the vehicle. By the detection of the situational awareness of the driver, by means of the driver monitoring device, in the event that the direction of travel indicators are activated, it can be confirmed that the driver is actively involved in the driving function. Accordingly, it can also be confirmed that the driver is still capable of interrupting the automated lane change maneuver, if necessary.

In known lane change assistance systems, it has previously been necessary for the driver to actuate the indicator lever, in order to initiate an automated lane change maneuver. Initiation and/or execution of the automated lane change maneuver is thus dependent upon predetermined operator actions, which actions, optionally, may not be intuitive for the driver. For example, it can be necessary for the indicator lever to be held in the one-touch indicator position for a specific time interval, but not moved into the latched position. In comparison, confirmation of the lane change maneuver by reference to the viewing direction or a confirmatory look is intuitive for the driver. Overall, the safety and convenience of automated lane change maneuvers can thus be enhanced.

In the event that a free gap for the vehicle is detected, and confirmation is executed by the driver, the vehicle, by means of the assistance system, can be maneuvered into the adjoining lane in an at least partially automated manner. The assistance system can thus intervene in the steering of the vehicle, or assume the lateral control thereof. It is preferably provided that, in conjunction with the automated lane change, longitudinal control of the vehicle is also assumed by means of the assistance system. For example, additionally, the speed of the vehicle can be adjusted for the lane change maneuver.

The computing device is preferably designed to output the offer signal for outputting the offer by the assistance system during hands-off operation wherein, during hands-off operation, a check of the attentiveness of the driver is executed by reference to attentiveness data. In other words, an offer for an automated lane change maneuver can be delivered to the driver with the vehicle in a “hands-off” operating mode. During hands-off operation, by means of the assistance system, automated lateral control is assumed, in order to maintain the vehicle within the lane. Thus, in particular, the function of a steering and tracking assistance system, or of an active lane keeping assistance system, is delivered. Preferably, in the event of hands-off operation, longitudinal control of the vehicle is also assumed in the form of ACC (adaptive cruise control). In particular, hands-off operation represents a function according to level 2 of SAE standard J3016.

During hands-off operation, the attentiveness of the driver can be ascertained on the basis of attentiveness data from the driver monitoring device. In particular, attentiveness data can be progressively monitored in order to determine whether the driver is distracted from their actual driving function. For example, a check can be executed as to whether the line of vision of the driver is directed towards the carriageway. By reference to attentiveness data, the viewing direction and/or head orientation of the driver can be evaluated. If it is established that the driver is not attentive, hands-off operation can be interrupted, and the driver can be instructed to place their hands on the steering wheel or to assume steering.

If the driver is attentive, in principle, it is not necessary for the driver to touch the steering wheel with their hands and/or to apply a steering wheel torque. This applies in general, subject to the proviso that no predefined interruption criterion for hands-off operation is fulfilled. During automated lateral control and, in particular, during automated longitudinal control, the driver can place their hands in a comfortable position. On the grounds that direction of travel indicators, in particular further to a confirmatory look by the driver, are activated automatically, it is not necessary for the driver to move their hands to an operator control element, for example to a steering column switch-mounted indicator lever, in order to confirm the lane change maneuver or to activate the direction of travel indicators. In this manner, a convenient driving experience is enabled for the driver in conjunction with the initiation of the lane change maneuver.

Thus, in particular, it is not necessary, upon the initiation of a lane change maneuver, for the presence of a hand upon the steering wheel to be detected in order to confirm driver attentiveness. In the present case, the detection of driver attentiveness can not only be executed exclusively by reference to the hand position but, alternatively, also by reference to the viewing direction and/or head orientation of the driver. It can thus be confirmed, to a comparable level, that the driver is conscious of their driving function. Moreover, the driver can thus be actively and intuitively alerted to their safeguarding responsibility.

Studies have shown that, in many cases, drivers are more attentive during hands-off operation than during the operation of a lane keeping assistance system, in which the application of hands to the steering wheel is required within specific time intervals. This may be attributable to a closer observation by the driver of driving maneuvers executed by the assistance system, and of surrounding traffic, during hands-off operation. In driving trials, during the preparation and execution of an automated lane change maneuver involving a confirmatory look, a high degree of attentiveness has also been confirmed. This may be attributable to the fact that, by means of a confirmatory look, the attention of the driver is directed to the free gap, and thereafter to the execution of the automated lane change maneuver.

Immediately the automated lane change maneuver has been confirmed by the confirmatory look of the driver, the vehicle can be moved in the direction of the target lane. The lane change maneuver can commence upon the contact of the first wheel of the vehicle with the carriageway marking, and terminate upon the crossing of the carriageway marking by the last wheel of the vehicle. Once the vehicle is located in the target lane, it can be maintained therein by means of automated tracking, with hands-off operation.

According to an alternative embodiment, the computing device is designed to output the offer signal for outputting the offer during hands-on operation. Thus, the lane change instruction initiated by the assistance system can also be output while the driver is holding the steering wheel, or has at least one hand in contact with the steering wheel. In the case of hands-on operation, an automated lateral control of the vehicle can be provided by way of a lane keeping assistance system. In principle, it can also be provided that lateral control is assumed manually by the driver. The offer for an automated lane change maneuver can also be displayed to the driver during hands-on operation. Further to a confirmatory look by the driver, the lane change maneuver can be executed in an automated manner, by means of the assistance system.

According to one embodiment, the region assigned to the free gap is determined such that this region incorporates the viewing direction and/or head orientation associated with a look into an exterior mirror which is oriented towards the free gap and/or with a look over the shoulder towards the free gap. Moreover, the region assigned to the free gap can incorporate a look into an interior mirror of the vehicle. By reference to attentiveness data from the driver monitoring device, a check can be executed as to whether the driver is looking into predefined regions, or regions of interest. For example, the situational awareness of the driver with respect to the forthcoming automated lane change maneuver can be confirmed by a look into the wing mirror, a look into the interior mirror, a look through the side window and/or a look over the shoulder. In particular, a check can thus be executed as to whether the driver is directing their vision in the direction of the exterior mirror or wing mirror of the vehicle which is assigned to the free gap or to the target lane. Alternatively or additionally, a check can be executed as to whether the driver directs a look over their shoulder in the direction of the free gap or in the direction of the target lane.

For the confirmation or acceptance of the offer, it can also be provided that the driver is required to look into at least two predefined regions, or assumes a head position which is directed towards at least two predefined regions. A corresponding combination of regions for the viewing direction and/or head orientation can thus be stipulated. A specific sequence of regions can also be stipulated. For example, for the acceptance of the offer, it can be required that the driver firstly looks into a region which is assigned to the interior mirror, and thereafter looks into a region which is assigned to the exterior mirror.

In particular, the look into the exterior mirror and/or the look over the shoulder are intuitive for the driver. The look into the exterior mirror and/or the look over the shoulder would also be executed by the driver in the event of a manual lane change maneuver. Customarily, this procedure or direction of vision is instructed in driving schools. Moreover, the impression can be created for the driver that their confirmatory look would entail a visual control of the vehicle, or a visual lateral control of the vehicle. By means of a viewing direction detection function for verifying safeguarding behavior on the part of the driver, it is possible for the driver, in a natural sequence of actions, to be involved in the automated lane change maneuver.

In the offer which is output for the attention of the driver by means of the output device, the driver can be instructed of the confirmatory look which is to be executed. For example, the driver can be instructed to monitor the traffic space or free gap. The driver can also be instructed to execute a look into a mirror or a look over the shoulder. Moreover, in the event of an unconfirmed lane change maneuver, it can be indicated that the lane change maneuver has not been initiated, on the grounds that no look into a mirror or look over the shoulder has been executed. The driver can thus be instructed of the confirmatory look which is to be executed.

For the look in the direction of the respective exterior mirror and/or for the respective look over the shoulder, viewing directions, pupil positions, head orientations, physical postures or respective solid angle ranges for these variables can be stipulated. To this end, for example, trials involving different drivers and/or calculations can be executed, in order to define these ranges. It can thus be ensured that the acceptance of the proposed lane change maneuver is executed reliably and, in particular, that any spurious confirmations are prevented.

Moreover, a check can be executed as to whether the driver looks into the at least one predefined region for a predefined minimum time interval. This minimum time interval can comprise, for example, between 100 ms and 1,000 ms, preferably between 350 ms and 800 ms. Only in the event that the driver looks into one of the predefined regions for the minimum time interval can this be interpreted as an acceptance. It is thus intended that looks into the wing mirror or looks over the shoulder of a sufficiently long duration are required for the execution of specific lane changes. It can thus be ensured that the driver intends to confirm the lane change maneuver, and has not looked into the region concerned at random. Overall, situational awareness and acceptance of the proposed lane change maneuver can thus be captured in a reliable manner.

According to a further embodiment, the computing device is designed to detect a traffic situation which dictates an automated lane change maneuver by reference to environmental data, by reference to speed data which describe a speed of the vehicle, and/or by reference to route data which describe a planned route. By means of the computing device, a traffic situation can be detected which dictates a lane change maneuver, or in which a lane change maneuver is appropriate. In order to enable an appraisal of the current traffic situation with respect to the necessity of a lane change, environmental data or an environmental model can be received by means of the computing device, which data or model describe further road users in the environment of the vehicle.

In order to enable an appraisal of the current traffic situation, moreover, data can be received by means of the computing device, which data describe the lane in which the ego-vehicle is presently located. To this end, for example, environmental data or image data from a camera of the vehicle and/or digital map data can be employed. Moreover, for the appraisal of the current traffic situation, speed data can additionally be received, which data describe a current speed of the vehicle. In particular, speed data can be ascertained on the basis of a set speed or target speed for the operation of an adaptive cruise control system or similar.

Moreover, for the appraisal of the current traffic situation or of forthcoming traffic situations, a course of the respective lane can be checked. The course of the lane can also describe whether a lane terminates and/or whether a lane continues in the further course of the road. Information on the course of lanes can be sourced from digital map data. Moreover, navigational route settings can be considered in the appraisal of the current traffic situation. For example, a lane change maneuver can be required in conjunction with an approach to an exit, or when a switchover to a different road is intended. Furthermore, for the appraisal of current traffic situations, data with respect to instantaneous traffic conditions, congestion, traffic density or similar can be considered.

On the basis of the speed of the ego-vehicle, speeds of respective further road users, the position of the ego-vehicle and of further road users in relation to the carriageway lane, the intended navigation route, traffic conditions and/or a course of lanes, by means of the computing device, a decision can then be executed as to whether, in the current traffic situation, a lane change by the ego-vehicle is dictated, appropriate or necessary. The computing device or the assistance system can detect relevant situations in which a lane change would be appropriate, and can notify the driver to this effect. A system-initiated and situation-based offer for an automated lane change maneuver can thus be issued for the attention of the driver of the vehicle.

Examples of traffic situations in which a lane change maneuver is dictated are as follows: an overtaking of slower road users, a switchover to the corresponding lane, in the event that the lane which is currently being navigated terminates, and/or a changeover to the corresponding lane in order to follow the desired route. A lane change maneuver can moreover be proposed to the driver, for example for the purposes of compliance with a keep-right requirement or another regulation.

According to a further embodiment, system-initiated lane change proposals or offers for automated lane change maneuvers are only proposed to the driver in the event that predefined activation criteria are fulfilled. By way of an activation criterion, for example, a check can be executed as to whether the vehicle is located on a road of a predefined road class. A road class of this type can be a freeway, or a freeway-type road. A further activation criterion can be the existence of an above-mentioned traffic situation which dictates a lane change maneuver. By way of a further activation criterion, a check can be executed as to whether a curvature of the road lies below a limiting value, such that a specific degree of comfort can be guaranteed. Additionally, by way of an activation criterion, a check can be executed as to whether predefined weather conditions are fulfilled. Moreover, by way of an activation criterion, a check can be executed to the effect that the vehicle is not presently located in a construction site. Furthermore, a check can be executed to the effect that no significant deceleration or braking of the vehicle is in force. Moreover, it is also possible for the automated lane change maneuver to only be offered up to a specified maximum speed of the vehicle.

According to a further embodiment, the computing device is designed, in the event of the detection of a traffic situation which dictates the automated lane change maneuver, to output a predefined maximum number of offer signals for the traffic situation thus detected. In the event that a traffic situation is detected which dictates the automated lane change maneuver, or in which the automated lane change maneuver is appropriate, a system-initiated proposal or offer can be output for the attention of the driver. It is preferably provided that, by means of the computing device, only the output of the maximum number of offer signals is executed. In particular, this signifies that, for a traffic situation thus detected, only a specific number of offers, for example three offers, are output for the attention of the driver. If these offers are not accepted by the driver, any further output of an offer associated with this traffic situation can be omitted.

In the event that, for example, the driver does not accept three sequential system-initiated offers, it can be assumed that the driver does not intend to execute a lane change maneuver. It can also be the case that the driver has not perceived, or has not understood these offers. In all these cases, it is intended to prevent that the driver is disturbed and/or unsettled by further offers. In the event of a subsequently detected traffic situation which dictates a lane change maneuver, further offers can then be output for the attention of the driver. For example, here again, the predefined maximum number of offer signals or offers can be output.

According to a further embodiment, the computing device is designed to output the activation signal and/or the steering signal, in the event that acceptance by the driver is executed within an offer time interval, wherein the outputting of the offer to the driver is executed during the offer time interval. By means of the computing device, the offer signal can be output such that the automated lane change maneuver is offered or proposed to the driver, by means of the output device, for the duration of the offer time interval. The offer time interval can comprise, for example, between 1 s and 10 s, preferably between 3 s and 7 s. During this offer time interval, or during the outputting of the offer, acceptance by the driver is also possible. The offer time interval can be selected such that sufficient time is provided to the driver for the perception of the offer, and for confirmation.

According to a further embodiment, the computing device is designed to actuate the direction of travel indicators, for the activation thereof, immediately further to acceptance by the driver or further to the establishment of situational awareness on the part of the driver. Immediately, by reference to attentiveness data, confirmation of the proposal for the automated lane change maneuver has been detected, by means of the computing device, outputting of the activation signal for activating the direction of travel indicators can be executed. Direction of travel indicators which are oriented towards the free gap can thus be activated immediately further to the confirmation of the proposed lane change. In particular, it is further provided that there is no temporal delay between the acceptance of the offer and the activation of the direction of travel indicators. A direct system feedback, further to acceptance by the driver, can thus be achieved. Moreover, other road users can be promptly alerted to the planned or forthcoming lane change maneuver.

It can further be provided that the computing device is designed to actuate the direction of travel indicators, for the activation thereof, in accordance with the current traffic situation and/or environmental conditions. In particular, the computing device is designed to define a time point for outputting the activation signal or for activating the direction of travel indicators in accordance with the current traffic situation and/or conditions in the surrounding area. The time point of activation can be defined, for example, in accordance with a traffic density, a profile and/or a gradient of the carriageway, a road type of the carriageway, the presence of a construction site, a current speed of the vehicle, a current speed of further users, weather conditions, a navigational route, or similar. In principle, activation of direction of travel indicators can also be executed independently of the outputting of the offer for the attention of the driver. In this manner, activation of the direction of travel indicators can be adapted to the current traffic situation.

Moreover, in the event of predefined or critical traffic situations, it can be provided that direction of travel indicators are activated temporally in advance of the outputting of the offer for the attention of the driver. If, for example, an urgent requirement or necessity for the lane change maneuver is in force, direction of travel indicators can be activated prior to the delivery of an output to the driver. A critical traffic situation of this type can involve, for example, merging with dense traffic. A critical situation of this type can also be in force, in the event that a lane change is to be executed in order to reach an exit. In this case, by the early activation of direction of travel indicators, other road users can be promptly alerted to the planned lane change maneuver and/or to the urgency or necessity of the planned lane change maneuver.

According to a further embodiment, the computing device is designed to output the steering signal such that a lateral movement of the vehicle for the initiation of the automated lane change maneuver only commences further to acceptance on the part of the driver. As described above, direction of travel indicators can be activated immediately further to the confirmation of the lane change offer. Lateral movement of the vehicle in the direction of the target lane can also commence further to the execution of the confirmatory look by the driver. It can be provided that the lateral movement commences simultaneously with the activation of the direction of travel indicators. It can also be provided that direction of travel indicators are activated firstly, and that the lateral movement commences thereafter. In particular, it is provided that the time interval between acceptance and the commencement of lateral movement is shorter than 1 s.

For the initiation of the lane change maneuver, the vehicle, by means of lateral movement in the direction of the carriageway marking between lanes, can be maneuvered between the lane in which the vehicle is presently located and the target lane. The time interval between the commencement of lateral movement and arrival at the carriageway marking can comprise, for example, up to 20 s, preferably up to 10 s and, in particular, between 2 s and 5 s. The duration of the lane change maneuver itself, which maneuver commences upon the contact of the first wheel of the vehicle with the carriageway marking, and terminates upon the crossing of the last wheel of the vehicle, can be shorter than 10 s and, in particular, shorter than 5 s.

According to a further embodiment, the computing device is designed to output the steering signal such that the lateral movement for the initiation of the automated lane change maneuver is halted, and the vehicle moves back to a defined position in the lane, in the event that a predefined interruption criterion is fulfilled. Initiation of the lane change maneuver can be interrupted and the vehicle directed back to the defined position in the lane, in the event that at least one predefined inhibition criterion or interruption criterion is fulfilled. If a criterion of this type is in force, the lateral movement of the vehicle in the direction of the carriageway marking can be terminated, and the vehicle can be maneuvered back to its starting position, with respect to lateral movement. For example, the vehicle can be steered back to the center of the lane. In particular, this redirection of the vehicle is only executed up to the time point at which the carriageway marking has yet to be crossed. For example, redirection can be executed within an interval of 2 s further to the commencement of the lateral movement of the vehicle.

In the event that an inhibition criterion or interruption criterion is fulfilled, moreover, by means of the computing device, a deactivation signal can be transmitted to the direction of travel indicators. Further to the transmission of the activation signal, the activated direction of travel indicators can then be deactivated. Other road users can thus be correspondingly notified.

An inhibition criterion or interruption criterion can be in force, for example, in the event that the lane change maneuver is no longer appraised as essential or necessary. A criterion of this type can also be in force in the event that the gap is no longer available, on the grounds that another road user has already moved into the gap. Moreover, a criterion of this type can be in force in the event that the stipulated operational design domain for the lane change maneuver is no longer in force and/or a maximum time for the initiation of the lane change maneuver has been exceeded.

In the operation of the assistance system, the driver, rather than by means of a confirmatory look, can also confirm the offer for the automated lane change maneuver by the operation of an operator control element, in particular of the indicator lever. It is preferably provided that, for the confirmation of the offer, the driver moves the indicator lever into the one-touch indicator position.

An assistance system according to the invention for the automated lateral control of a vehicle comprises a computing device according to the invention. The computing device can be formed by at least one processor or by at least one electronic control device. Moreover, the assistance system can comprise at least one environmental sensor, by means of which environmental data can be supplied. By way of an environmental sensor, the assistance system can comprise a camera, by means of which image data which describe the environment of the vehicle can be supplied. By means of the computing device, carriageway markings and/or other delimitations of the carriageway or of lanes can then be detected in image data. Moreover, objects and further road users can be detected in image data. Furthermore, by way of an environmental sensor, the assistance system can comprise at least one distance sensor, which sensor can be configured as a radar sensor and/or as a LiDAR sensor. By reference to sensor data from these distance sensors, for example, further road users can be captured, and the speeds of further road users can also be determined.

The assistance system can moreover comprise the driver monitoring device, by means of which the delivery of attentiveness data is enabled. The driver monitoring device can comprise an interior camera and corresponding light sources, in particular light sources which emit light in the infrared wavelength spectrum. On the basis of these attentiveness data, by means of the computing device, during hands-off operation, a check can be executed as to whether the driver is attentive, or whether their attention is directed towards traffic conditions. Moreover, by reference to attentiveness data, a check can be executed as to whether a situational awareness of the driver with respect to the planned automated lane change maneuver is in force, or whether a confirmatory look has been executed by way of an acceptance of the automated lane change maneuver.

The assistance system can further comprise the output device, by means of which optical, acoustic and/or haptic outputs can be delivered for the attention of the driver. The output device, by means of the computing device, can be actuated further to the transmission of the offer signal, such that the offer or proposal for the lane change maneuver is delivered to the driver.

By means of the computing device of the assistance system, the steering system of the vehicle can be actuated, in order to assume the lateral control of the vehicle. The vehicle can thus be maintained, for example, within the track or lane. The steering system can moreover be actuated for the execution of the lane change maneuver. Preferably, by means of the computing device, a braking system and/or a drive motor can also be actuated, in order to assume a longitudinal control of the vehicle.

A vehicle according to the invention comprises an assistance system according to the invention. In particular, the vehicle is configured as a passenger car.

A method according to the invention is employed for the automated lateral guidance of a vehicle. The method comprises the identification of a free gap for an automated lane change maneuver, by reference to environmental data. The method further comprises the output of an offer signal for outputting an offer to the driver for the automated lane change maneuver. The method moreover comprises the reception of attentiveness data, which attentiveness data describe a viewing direction and/or a head orientation of the driver. The method additionally comprises a determination as to whether a situational awareness of the driver with respect to the automated lane change maneuver is in force, by way of an acceptance of the offer, wherein this situational awareness describes a turning of the viewing direction and/or of the head orientation towards a region which is assigned to the free gap. The method moreover comprises the outputting of an activation signal for the activation of direction of travel indicators of the vehicle. The method furthermore comprises the outputting of a steering signal for actuating a steering system of the vehicle, for the execution of the automated lane change maneuver, in the event that situational awareness is in force.

A further aspect of the invention relates to a computer program comprising commands which, upon the execution of the program by the computing device, initiate the execution thereby of a method according to the invention, and of advantageous configurations thereof. The invention moreover relates to a computer-readable storage medium comprising commands which, upon the execution thereof by the computing device, initiate the execution thereby of a method according to the invention, and of advantageous configurations thereof.

Preferred embodiments proposed with respect to the computing device according to the invention, and the advantages thereof, apply in a corresponding manner to the assistance system according to the invention, to the vehicle according to the invention, to the computer program according to the invention, and to the computer-readable storage medium according to the invention.

Further features of the invention proceed from the claims, the figures and the description of the figures. Features and combinations of features specified in the preceding description, and features and combinations of features specified hereinafter in the description of the figures and/or represented in the figures alone are not only applicable in the respectively indicated combination, but also in other combinations or in isolation, without departing from the scope of the invention.

The invention is described in greater detail hereinafter with respect to preferred exemplary embodiments, and with reference to the attached drawings.

### BRIEF DESCRIPTION OF THE DRAWINGS

FIG. 1 shows a schematic representation of a vehicle which comprises an assistance system for the automated lateral control of the vehicle;

FIG. 2 shows a schematic representation of a traffic situation in which the vehicle according to FIG. 1 is located in a right-hand lane of a road, and in which a heavy goods vehicle is traveling ahead of the vehicle;

FIG. 3 shows a schematic representation of a display which is presented to the driver, wherein the display comprises a depiction of the vehicle, the heavy goods vehicle and the lane, and wherein the display comprises an offer for an automated lane change maneuver;

FIG. 4 shows a schematic representation of the driver in an interior of the vehicle, wherein the driver, for the confirmation of the offer for the automated lane change maneuver, looks into an exterior mirror of the vehicle;

FIG. 5 shows a schematic representation of potential regions into which the driver can direct their vision, in order to confirm the lane change maneuver; and

FIG. 6 shows the traffic situation according to FIG. 2 at a later time point, at which the automated lane change maneuver from the right-hand lane to the left-hand lane has been initiated.

### DETAILED DESCRIPTION OF THE DRAWINGS

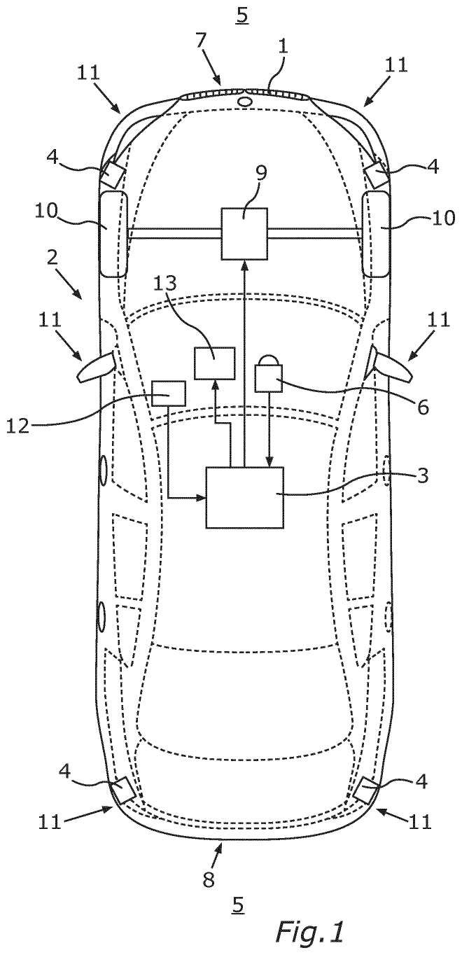

FIG. 1 shows a vehicle 1 which, in the present case, is configured as a passenger car, in an overhead view. The vehicle 1 comprises an assistance system 2, by means of which automated lane change maneuvers of the vehicle 1 can be executed. The assistance system 2 comprises a computing device 3 which can be formed, for example, by at least one electronic control device of the vehicle 1.

The assistance system 2 moreover comprises at least one distance sensor 4, by way of an environmental sensor. In the present example, the assistance system 2 comprises four distance sensors 4, of which two distance sensors 4 are assigned to a front end 7 and two distance sensors 4 are assigned to a rear end 8. The distance sensors 4 are arranged at respective corners of the rear end 8 of the vehicle 1 and of the front end 7 of the vehicle 1. The distance sensors 4 can be configured, for example, as radar sensors. By means of the distance sensors 4, corresponding measurements can be executed, in order to the enable the capture of objects in an environment 5 of the vehicle 1. In the present case, corresponding data lines between the distance sensors 4 and the computing device 3 are not represented, in the interests of clarity.

By way of an environmental sensor, the assistance system 2 further comprises a camera 6, by means of which the supply of image data or environmental data which describe the environment 5 of the vehicle 1 is enabled. By means of the computing device 3, environmental data from the distance sensors 4 and the camera 6 can be processed and thus, for example, objects, further road users 18, carriageway markings 17 or similar in the environment 5 can be detected.

The computing device 3 is furthermore designed to actuate a steering system 9 of the vehicle 1 which, in the present case, is represented in a schematic manner only. By the actuation of the steering system 9, a lateral control of the vehicle 1 can be executed for the maintenance of the vehicle 1 in a lane 15, 16, and/or in conjunction with lane change maneuvers. By the actuation of the steering system 9, steerable wheels 10 of the vehicle 1 can be steered, and lateral control associated with the lane change maneuver assumed accordingly. Additionally, by means of the computing device 3, a drive motor and a braking system of the vehicle 1 can preferably be actuated in order to execute the longitudinal control of the vehicle 1, particularly by way of an adaptive cruise control.

The assistance system 2 moreover comprises a driver monitoring device 12, by means of which an attentiveness of a driver 19 of the vehicle 1 can be captured. The driver monitoring device 12 can comprise an interior camera, by means of which a viewing direction of the driver 19, a head position of the driver 19 and/or a physical posture of the driver 19 can be captured. The assistance system 2 further comprises an output device 13, by means of which an output can be delivered for the attention of the driver 19. Outputting of the output can be executed acoustically, optically and/or haptically.

The computing device 3 is moreover designed to actuate direction of travel indicators 11 of the vehicle 1. To this end, an activation signal can be transmitted by the computing device 3 to the direction of travel indicators 11. Further to actuation, the direction of travel indicators 11 can be activated, such that an indicator signal is output by the direction of travel indicators 11. By means of a further actuation, the direction of travel indicators 11 can also be deactivated. Direction of travel indicators 11 can thus be actuated independently of any operation of an operator control element, for example an indicator lever, by the driver 19.

The computing device 3 is further supplied with data which describe the current speed of the vehicle 1 and/or a set speed for adaptive cruise control. On the basis of measurements from environmental sensors, i.e. from the distance sensors 4 and the camera 6, the speeds of further road users 18 can be determined. Moreover, on the basis of data from environmental sensors 4, 6 and/or by reference to digital map data, in combination with a satellite-supported positioning system, the lane 15, 16 of a road 14 in which the vehicle 1 is currently located can be ascertained. By reference to this information, by means of the computing device 3, it can be ascertained whether a lane change is necessary or appropriate in a current traffic situation.

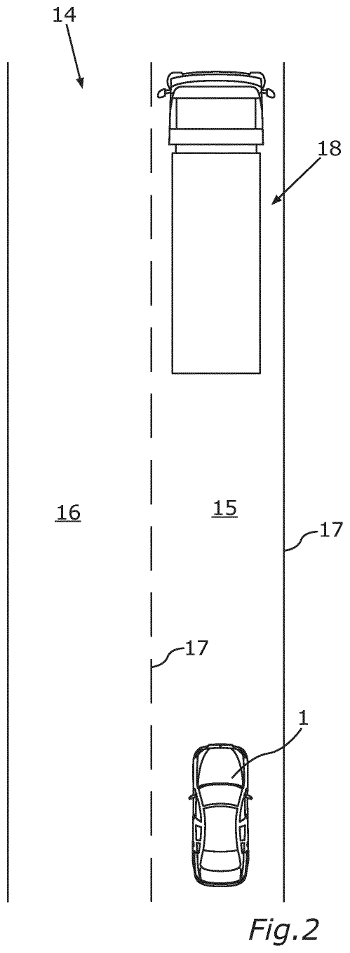

FIG. 2 shows the vehicle 1 according to FIG. 1 in an exemplary traffic situation. The vehicle 1 is located on a road 14 having a right-hand lane 15 and a left-hand lane 16. It is assumed that, during the travel of the vehicle 1, an automated lane change is executed by means of the assistance system 2. By reference to data from environmental sensors, and from the camera 6 in particular, carriageway markings 17 on the road 14 can be detected. The steering system 9 can then be actuated such that the vehicle 1 is maintained within the lane 15.

By means of the assistance system 2, moreover, a “hands-off” operation is enabled. This means that the driver 19 can remove their hands 20 from the steering wheel 21 provided that, by reference to data from the driver monitoring system 12, it is detected that the driver 19 is attentive. Attentiveness on the part of the driver 19 is assumed in the event that the latter directs their vision towards the road 14. If attentiveness on the part of the driver 19 is in force, automated tracking is continuously assumed by the assistance system 2, without the necessity for the driver 19 to return their hands 20 to the steering wheel 21 after a specific time interval. Moreover, by means of the assistance system 2, the speed of the vehicle 1 can be regulated to the set speed, and a clearance to a further road user 18, which is traveling ahead, can be maintained.

In the traffic situation represented in FIG. 2, the vehicle 1 is located in the right-hand lane 15. Ahead of the vehicle 1, in the direction of travel thereof, a further road user 18 is present in the form of a heavy goods vehicle. It is assumed that a set speed or target speed of the vehicle 1 is adjusted to 120 km/h. The speed of the further road user 18, or the relative speed between the vehicle 1 and the further road user 18, can be determined by reference to data from the environmental sensors 4, 6. It is assumed that the further road user 18 is traveling at a significantly lower speed than the vehicle 1, for example at a speed of 80 km/h. A lane change from the right-hand lane 15 to the left-hand lane 16 is therefore required, in order to maintain speed.

The requisite lane change is automatically detected by means of the assistance system 2. Moreover, by means of the assistance system 2, a check is executed as to whether a lane change maneuver from the right-hand lane 15 to the left-hand lane 16 is possible. To this end, on the basis of sensor data from the environmental sensors 4, 6, a check is executed as to whether a free gap 26 is available in the lane 16 for the lane change maneuver. In the event that a free gap 26 is available, by means of the assistance system 2, an offer for an automated lane change maneuver from the right-hand lane 15 to the left-hand lane 16 is then generated for the attention of the driver 19. To this end, an offer for the automated lane change maneuver can be output for the attention of the driver by means of the output device 13.

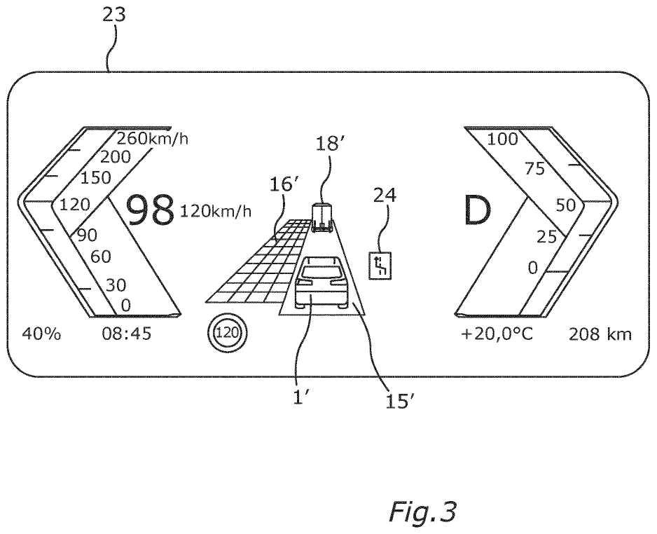

FIG. 3 shows a schematic representation of a read-out 23 which can be displayed to the driver 19 during the offer for the automated lane change maneuver.

For example, the read-out 23 can be displayed on an instrument cluster 22 which is an element of the output device 13. In a known manner, the read-out 23 shows a speed indicator display and a power indicator display. The read-out 23 moreover represents the environment 5 of the vehicle 1, and shows a depiction 1′ of the vehicle 1, and a depiction 18′ of the further road user 18 or of the heavy goods vehicle. Moreover, the read-out 23 shows a depiction 15′ of the right-hand lane 15 and a depiction 16′ of the left-hand lane 16.

In the example represented, the driver 19 is alerted to the offer with respect to the automated lane change from the right-hand lane 15 to the left-hand lane 16 by means of the symbol 24. This symbol 24 describes the movement of the vehicle 1 associated with the forthcoming lane change maneuver, or the trajectory executed by the vehicle 1 in conjunction with the lane change maneuver. The symbol 24 thus alerts the driver 19 intuitively to the potential automated lane change maneuver. In combination with the representation of the symbol 24, moreover, an acoustic signal or audible alert can be output. It can further be provided that, additionally or alternatively to the symbol 24, a text is displayed which alerts the driver 19 to the potential automated lane change and/or to the operator control action which is to be executed for the confirmation of the lane change maneuver.

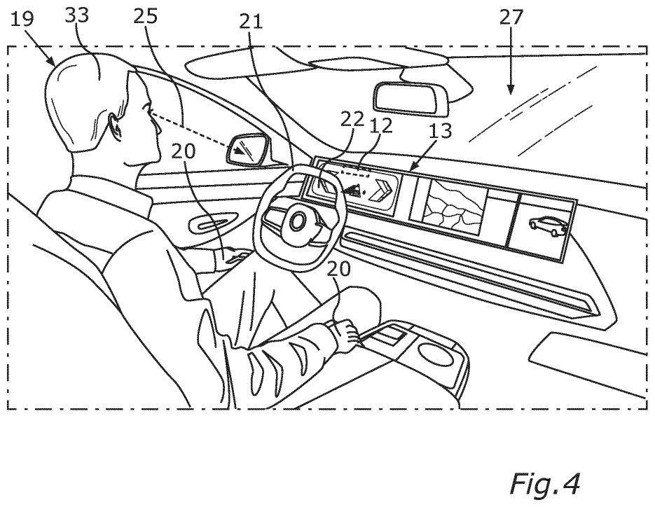

FIG. 4 shows the driver 19, who is located in an interior 27 of the vehicle 1. The vehicle 1 is presently being maneuvered by means of the assistance system 2, in “hands-off” operation, such that the driver 19 can position their hands 20 comfortably, and it is not necessary for their hands 20 to be applied to the steering wheel 21. The read-out 23 according to FIG. 3 has displayed an offer for the automated lane change maneuver for the attention of the driver 19. For the execution of the automated lane change maneuver by means of the assistance system 2, it is necessary for the driver 19 to confirm the offer for the automated lane change maneuver.

For the purposes of confirmation, it is necessary for the driver 19 to verify the lane change maneuver or the traffic space for the planned lane change maneuver. To this end, it is provided that the driver 19 orients their viewing direction 25 towards the free gap 26 in the left-hand lane 16. In order to instruct the driver 19 of the requisite behavior for confirmation, a corresponding text can be displayed in the read-out 23 according to FIG. 3. The driver 19 can be instructed to monitor traffic or the free gap 26. The driver 19 can also be instructed to execute a look over the shoulder or a look into a mirror. For example, in the present traffic situation, an instruction can be displayed to “Check traffic, in order to move into the faster lane”.

FIG. 4 moreover shows a characteristic representation of the region in which the driver monitoring device 12 for monitoring the viewing direction 25, the head orientation 33 and/or the physical posture of the driver 19 is arranged. The vehicle monitoring device 12 can be arranged in the region of the instrument cluster 22 or combination of instruments.

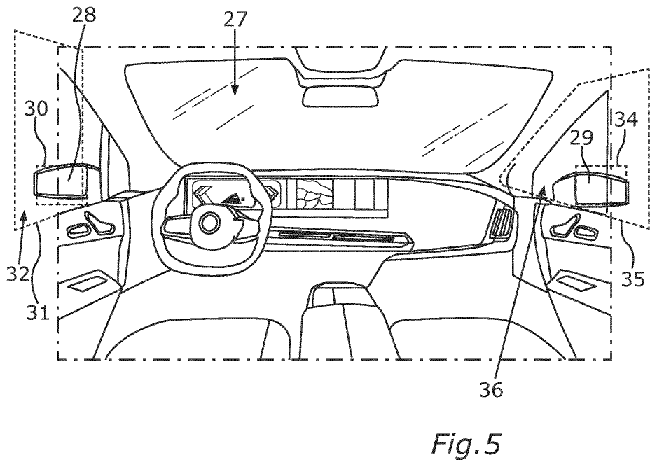

In order to confirm the lane change maneuver, it is necessary for the driver 19 to look into the exterior mirror 28 and/or to execute a look over the shoulder. This is illustrated with reference to FIG. 5, which shows the interior 27 of the vehicle 1. If a lane change maneuver to a lane which is situated to the left of the vehicle 1 is to be confirmed, it is necessary for the driver 19 to direct their vision towards the left-hand exterior mirror 28. The region 30 schematically characterizes the region which is assigned to the left-hand exterior mirror 28. Alternatively or additionally, the driver 19, for the confirmation of the lane change maneuver into the left-hand lane which is adjacent to the vehicle 1, can look into the region 31, which region describes a look over the shoulder through the left-hand vehicle window 32. For the regions 30 and 31, respective angular ranges can be stipulated for the viewing direction and/or for the rotation of the head 33. For example, a minimum rotation of the head 33 through an angle of 42° to the left can be assigned to the region 31.

If a lane change maneuver to a lane which is situated to the right of the vehicle 1 is to be confirmed, it is necessary for the driver 19 to direct their vision towards the right-hand exterior mirror 29. The region 34 schematically characterizes the region which is assigned to the right-hand exterior mirror 29. Alternatively or additionally, the driver, for the confirmation of the lane change maneuver into a right-hand lane which is adjacent to the vehicle 1, can look into the right-hand lane which is adjacent to the vehicle 1 into the region 31, which region describes a look over the shoulder through the right-hand vehicle window 36. Corresponding viewing directions and/or head positions can also be stipulated for the regions 34 and 35. The regions 30, 31, 34 and 35 are to be understood as exemplary. Further regions can also be stipulated.

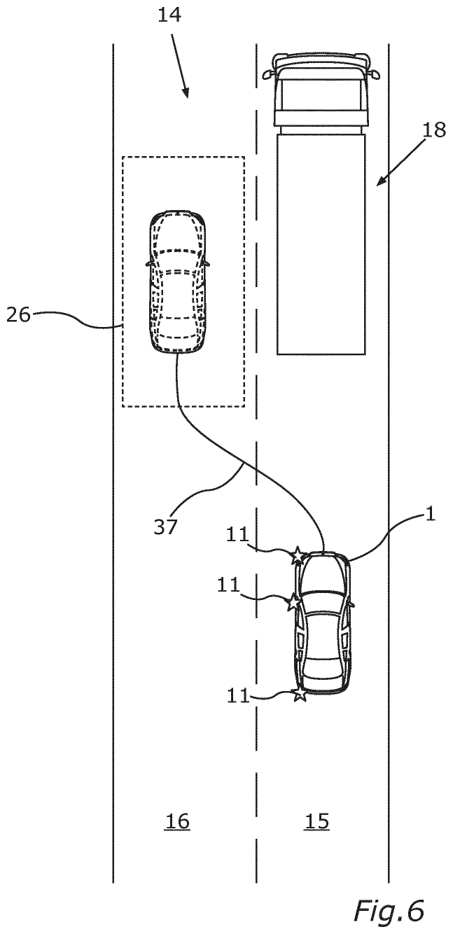

FIG. 6 shows the traffic situation according to FIG. 2 at a later time point, or further to the confirmation of the automated lane change maneuver by the driver 19. Further to the confirmation of the lane change maneuver, direction of travel indicators 11 which are assigned to the left-hand lane 16 are activated automatically by means of the assistance system 2 or by means of the computing device 3. It is thus not necessary for the driver 19 to actuate an operator control element, for example an indicator lever, in order to activate the direction of travel indicators 11.

Further to the activation of the direction of travel indicators 11, the vehicle 1 is then maneuvered from the right-hand lane 14 into the left-hand lane 15 by means of the assistance system 2, in an automated manner, along a trajectory 37.

1-11. (canceled)

12. A computing device for an assistance system for the automated lateral control of a vehicle, wherein the computing device comprises:
a memory storing processor executable software; and
a processor configured via execution of the software to:
determine a free gap for an automated lane change maneuver by reference to environmental data,
output an offer signal for outputting an offer to a driver for the automated lane change maneuver,
receive attentiveness data that describes a viewing direction and/or a head orientation of the driver,
determine whether a situational awareness of the driver for the automated lane change maneuver is in force by way of an acceptance of the offer, wherein the situational awareness describes a turning of the viewing direction and/or of the head orientation towards a region which is assigned to the free gap,
output an activation signal for automatically activating direction of travel indicators of the vehicle, and
when the situational awareness is in force, output a steering signal for actuating a steering system of the vehicle for the execution of the automated lane change maneuver.

13. The computing device of claim 12, wherein the computing device is further configured to:
output the offer signal for outputting the offer by the assistance system during hands-off operation,
wherein, during hands-off operation, a check of the attentiveness of the driver is executed by reference to attentiveness data.

14. The computing device of claim 12, wherein the region assigned to the free gap is determined in order to incorporate the viewing direction and/or head orientation associated with a look into an exterior mirror which is oriented towards the free gap and/or with a look over the shoulder towards the free gap.

15. The computing device of claim 12, wherein the computing device is further configured to:
detect a traffic situation that dictates an automated lane change maneuver by reference to: environmental data, speed data describing the speed of the vehicle, and/or route data describing a planned route.

16. The computing device of claim 15, wherein the computing device is further configured to:
when a traffic situation that dictates the automated lane change maneuver is detected, output a predefined maximum number of offer signals for the detected traffic situation.

17. The computing device of claim 12, wherein the computing device is further configured to:
output the activation signal and/or the steering signal when acceptance by the driver is executed within an offer time interval,
wherein the outputting of the offer to the driver is executed during the offer time interval.

18. The computing device of claim 12, wherein the computing device is further configured to:
output the activation signal for activating direction of travel indicators upon the acceptance of the offer by the driver.

19. The computing device of claim 12, wherein the computing device is configured to:
output the steering signal such that a lateral movement of the vehicle for the initiation of the automated lane change maneuver only commences upon acceptance on the part of the driver.

20. The computing device of claim 19, wherein the computing device is configured to output the steering signal such that the lateral movement for the initiation of the automated lane change maneuver is halted, and the vehicle moves back to a defined position in a lane, when a predefined interruption criterion is fulfilled.

21. An assistance system for the automated lateral control of a vehicle, comprising the computing device of claim 12.

22. A method for the automated lateral control of a vehicle, comprising:
identifying a free gap for an automated lane change maneuver, by reference to environmental data;
outputting an offer signal for outputting an offer to the driver for the automated lane change maneuver;
receiving attentiveness data that describes a viewing direction and/or a head orientation of the driver;
determining whether a situational awareness of the driver with respect to the automated lane change maneuver is in force, by way of an acceptance of the offer, wherein the situational awareness describes a turning of the viewing direction and/or of the head orientation towards a region assigned to the free gap;
outputting an activation signal for the activation of direction of travel indicators of the vehicle; and
outputting a steering signal for actuating a steering system of the vehicle, for the execution of the automated lane change maneuver, when the situational awareness is in force.
